(19) United States
(12) Patent Application Publication
(10) Pub. No.: US 2025/0354879 A1
(43) Pub. Date: Nov. 20, 2025

(54) MONITORING SYSTEM OF OFFSHORE WINDFARM POWER CABLE USING FIBER-OPTIC DISTRIBUTED ACOUSTIC SENSING

(71) Applicant: NEC Laboratories America, Inc., Princeton, NJ (US)

(72) Inventors: Wataru KOHNO, PRINCETON, NJ (US); Yue TIAN, Princeton, NJ (US); Sarper OZHARAR, PENNINGTON, NJ (US); Yangmin DING, EAST BRUNSWICK, NJ (US); Zhuocheng JIANG, PLAINSBORO, NJ (US); Ting WANG, WEST WINDSOR, NJ (US)

(73) Assignee: NEC Laboratories America, Inc., Princeton, NJ (US)

(21) Appl. No.: 19/210,984

(22) Filed: May 16, 2025

Related U.S. Application Data
(60) Provisional application No. 63/648,838, filed on May 17, 2024.

(51) Int. Cl. G01L 1/24; G01H 9/00

(52) U.S. Cl. CPC G01L 1/242; G01H 9/004

(57) ABSTRACT

Disclosed are systems and methods employing distributed fiber optic sensing (DFOS)/distributed acoustic sensing (DAS) that continuously monitor the buried/exposed status of undersea power cables for offshore wind farms. Our DAS systems and methods continuously monitor dynamic conditions characterizing undersea power cables and advantageously detect dynamic strain of an optical fiber that may be part of a composite cable with the power cable. By measuring and monitoring these dynamic conditions, a change in status from buried to exposed is determined and service personnel deployed before damage occurs to the power cable.

### CROSS REFERENCE TO RELATED APPLICATIONS

This application claims the benefit of U.S. Provisional Patent Application Ser. No. 63/648,838 filed May 17, 2024, the entire contents of each of which is incorporated by reference as if set forth at length herein.

### FIELD OF THE INVENTION

This application relates generally to distributed fiber optic sensing (DFOS) systems, methods, and structures. More particularly, it pertains to improved DFOS/Distributed Acoustic Sensing (DAS) systems and methods for monitoring power cables in offshore windfarms.

### BACKGROUND OF THE INVENTION

As those skilled in the art will understand and appreciate, offshore wind farms are a collection of wind turbines that are electrically connected to a mainland and/or each other via composite, subsea cables to transmit generated electrical power to a distribution network. Oftentimes, these composite subsea cables also include optical fiber cables and are located either below the seabed or on the seabed itself.

For these offshore wind farms, monitoring the subsea cables is particularly challenging as direct visual observation is difficult, and physical damage to the cables from external forces such as strong currents, fishing activities, and ship anchors is oftentimes realized. Accordingly, techniques that facilitate the convenient, economic, and effective monitoring of subsea cables would represent a welcome addition to the art.

### SUMMARY OF THE INVENTION

An advance in the art is made according to aspects of the present disclosure directed to systems and methods that employ distributed fiber optic sensing (DFOS)/distributed acoustic sensing (DAS) to monitor undersea power cables for offshore wind farms.

In sharp contrast to the prior art, systems and methods according to aspects of the present disclosure continuously monitor the dynamic conditions characterizing undersea cable environments by DAS, which advantageously detects dynamic strain of an optical fiber—oftentimes part of a composite cable with the power cable—the phase changes in Rayleigh backscattered light (Phase-sensitive OTDR, Φ-OTDR).

### BRIEF DESCRIPTION OF THE DRAWING

FIG. 1(A) and FIG. 1(B) are schematic diagrams showing an illustrative prior art uncoded and coded DFOS systems.

FIG. 2 is a schematic diagram showing an illustrative offshore windfarm with power cable and optical fiber sensor monitoring according to aspects of the present disclosure.

FIG. 3 is a schematic diagram showing illustrative relation between wind, sea wave height, and a buried optical fiber in the seabed according to aspects of the present disclosure.

FIG. 4 is a schematic diagram showing illustrative changes in cable status, from buried to exposed according to aspects of the present disclosure.

FIG. 5 is a schematic block diagram showing illustrative features of systems and methods according to aspects of the present disclosure.

FIG. 6 is a schematic flow diagram showing illustrative operational aspects of systems and methods according to aspects of the present disclosure.

FIG. 7 is a plot showing illustrative fiber deployment in a simulation (left) and one of the simulated results plotted in space and time, and corresponding 2D power spectrums (right) according to aspects of the present disclosure.

FIG. 8 shows a series of plots of illustrative simulated patterns of space-time phase data with 2D power spectrum according to aspects of the present disclosure.

FIG. 9 shows an illustrative example of changes in a buried cable from buried to exposed according to aspects of the present disclosure.

FIG. 10 shows a pair of plots of illustrative power spectrum when VIV affects the cable and deployment indices corresponding to changes in cable status as illustratively shown in FIG. 9, according to aspects of the present disclosure.

FIG. 11 shows a histogram of the deployment indices in 90 sec when the cable is exposing, and localization result based on the threshold according to aspects of the present disclosure.

FIG. 12 shows a feature diagram in hierarchical format of features and operation steps of systems and methods according to aspects of the present disclosure.

FIG. 13 is a schematic block diagram of an illustrative computer system in which aspects of the present disclosure may be executed.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGS. comprising the drawing are not drawn to scale.

By way of some additional background, we note that distributed fiber optic sensing systems convert the fiber to an array of sensors distributed along the length of the fiber. In effect, the fiber becomes a sensor, while the interrogator generates/injects laser light energy into the fiber and senses/detects events along the fiber length.

As those skilled in the art will understand and appreciate, DFOS technology can be deployed to continuously monitor vehicle movement, human traffic, excavating activity, seismic activity, temperatures, structural integrity, liquid and gas leaks, and many other conditions and activities. It is used around the world to monitor power stations, telecom networks, railways, roads, bridges, international borders, critical infrastructure, terrestrial and subsea power and pipelines, and downhole applications in oil, gas, and enhanced geothermal electricity generation. Advantageously, distributed fiber optic sensing is not constrained by line of sight or remote power access and—depending on system configuration—can be deployed in continuous lengths exceeding 30 miles with sensing/detection at every point along its length. As such, cost per sensing point over great distances typically cannot be matched by competing technologies.

Distributed fiber optic sensing measures changes in “backscattering” of light occurring in an optical sensing fiber when the sensing fiber encounters environmental changes including vibration, strain, or temperature change events. As noted, the sensing fiber serves as sensor over its entire length, delivering real time information on physical/environmental surroundings, and fiber integrity/security. Furthermore, distributed fiber optic sensing data pinpoints a precise location of events and conditions occurring at or near the sensing fiber.

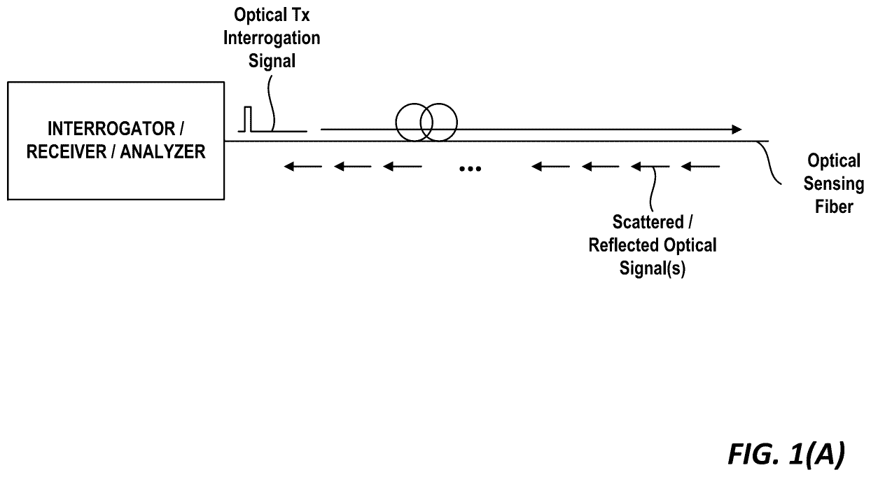

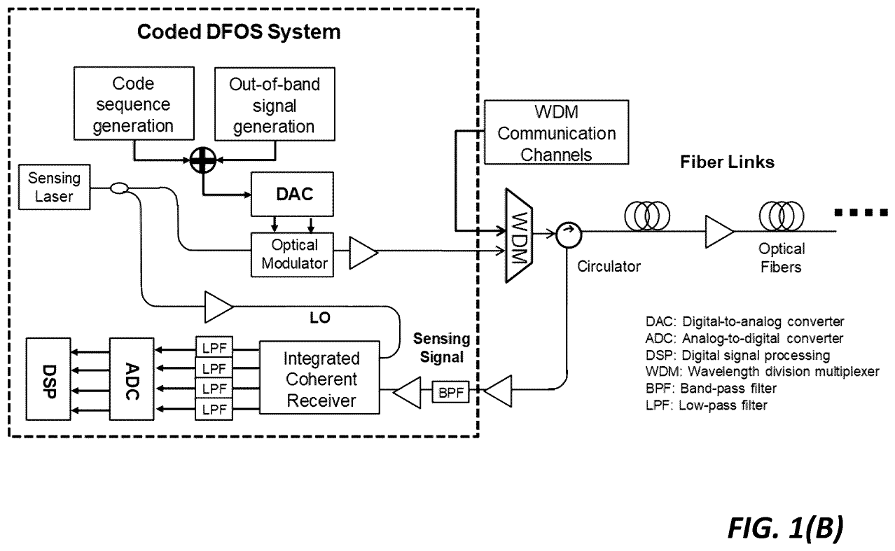

A schematic diagram illustrating the generalized arrangement and operation of a distributed fiber optic sensing system that may advantageously include artificial intelligence/machine learning (AI/ML) analysis is shown illustratively in FIG. 1(A). With reference to FIG. 1(A), one may observe an optical sensing fiber that in turn is connected to an interrogator. While not shown in detail, the interrogator may include a coded DFOS system that may employ a coherent receiver arrangement known in the art such as that illustrated in FIG. 1(B).

As is known, contemporary interrogators are systems that generate an input signal to the optical sensing fiber and detect/analyze reflected/backscattered and subsequently received signal(s). The signals received are analyzed, and an output is generated which is indicative of the environmental conditions encountered along the length of the fiber. The backscattered signal(s) so received may result from reflections in the fiber, such as Raman backscattering, Rayleigh backscattering, and Brillion backscattering.

As will be appreciated, a contemporary DFOS system includes the interrogator that periodically generates optical pulses (or any coded signal) and injects them into an optical sensing fiber. The injected optical pulse signal is conveyed along the length optical fiber.

At locations along the length of the fiber, a small portion of signal is backscattered/reflected and conveyed back to the interrogator wherein it is received. The backscattered/reflected signal carries information the interrogator uses to detect, such as a power level change that indicates—for example—a mechanical vibration or an indication of temperature.

The received backscattered signal is converted to electrical domain and processed inside the interrogator. Based on the pulse injection time and the time the received signal is detected, the interrogator determines at which location along the length of the optical sensing fiber the received signal is returning from, thus able to sense the activity of each location along the length of the optical sensing fiber. Classification methods may be further used to detect and locate events or other environmental conditions including acoustic and/or vibrational and/or thermal along the length of the optical sensing fiber.

Distributed acoustic sensing (DAS) is a technology that uses fiber optic cables as linear acoustic sensors. Unlike traditional point sensors, which measure acoustic vibrations at discrete locations, DAS can provide a continuous acoustic/vibration profile along the entire length of the cable. This makes it ideal for applications where it's important to monitor acoustic/vibration changes over a large area or distance.

Distributed acoustic sensing/distributed vibration sensing (DAS/DVS), also sometimes known as just distributed acoustic sensing (DAS), is a technology that uses optical fibers as widespread vibration and acoustic wave detectors. Like distributed temperature sensing (DTS), DAS/DVS allows continuous monitoring over long distances, but instead of measuring temperature, it measures vibrations and sounds along the fiber.

DAS/DVS operates as follows. Light pulses are sent through the fiber optic sensor cable. As the light travels through the cable, vibrations and sounds cause the fiber to stretch and contract slightly. These tiny changes in the fiber's length affect how the light interacts with the material, causing a shift in the backscattered light's frequency. By analyzing the frequency shift of the backscattered light, the DAS/DVS system can determine the location and intensity of the vibrations or sounds along the fiber optic cable.

DAS/DVS offers several advantages over traditional point-based vibration sensors: High spatial resolution: It can measure vibrations with high granularity, pinpointing the exact location of the source along the cable; Long distances: It can monitor vibrations over large areas, covering several kilometers with a single fiber optic sensor cable; Continuous monitoring: It provides a continuous picture of vibration activity, allowing for better detection of anomalies and trends; Immune to electromagnetic interference (EMI): Fiber optic cables are not affected by electrical noise, making them suitable for use in environments with strong electromagnetic fields.

DAS/DVS technologies have proven useful in a wide range of applications, including: Structural health monitoring: Monitoring bridges, buildings, and other structures for damage or safety concerns; Pipeline monitoring: Detecting leaks, blockages, and other anomalies in pipelines for oil, gas, and other fluids; Perimeter security: Detecting intrusions and other activities along fences, pipelines, or other borders; Geophysics: Studying seismic activity, landslides, and other geological phenomena; and Machine health monitoring: Monitoring the health of machinery by detecting abnormal vibrations indicative of potential problems.

Distributed Fiber Optic Sensing (DFOS) technology leverages the existing fiber infrastructures as a potential sensing media, enabling a wide-range, real-time, and continuous monitoring of surrounding environment perception without the need to introduce additional sensing devices. DFOS has been successfully employed in diverse applications including road traffic monitoring, intrusion detection, earthquake detection, pipeline leakage monitoring and structure change detection.

Operational telecommunications optical fiber cable networks hold substantial potential for environmental perception and sensing applications. DFOS technology transforms existing communication cables into individual sensors distributed at every meter along the optical fiber cable, with all the measurements being synchronized. As a result, this sensing technology can be employed to detect events related to both infrastructure itself and its surrounding environments.

As previously noted, a basic principle behind the DFOS is that optical fiber cable conditions such as a change of strain or temperature on the optical fiber cable can influence the properties of the light signal traveling through an optical fiber. When pulsed light is launched into an optical fiber sensing cable, a small fraction of light is backscattered, and its properties are influenced by the fiber cable condition. The backscattered light includes three types of scattering: Raman scattering, Brillouin scattering, and Rayleigh scattering. This methodology gauges alterations in Rayleigh scattering intensity via interferometric phase beating. With coherent detection, the DFOS system retrieves comprehensive polarization and phase information from the backscattering signals, enabling impressive meter-level fiber cable sensor resolution.

As others have previously noted, the continual need for sustainable energy sources has resulted in the development and adoption of renewable energy at an accelerated pace. Wind energy, recognized for delivering clean and dependable power, has great potential for next-generation energy resources.

Due to their location in the open sea, where they can capture higher and more consistent wind speeds than on land, offshore wind farms are acknowledged for their ability to generate stable energy. With this background, a significant number of these facilities have already been constructed, and the trend is set to continue, reflecting a commitment to further harness the sea's potential.

Wind power generators within wind farms convert the kinetic energy from wind turbines into electrical energy, typically integrated directly into the turbines themselves. Consequently, power cables that transmit this electrical energy to substations are installed concurrently with the construction of wind farms.

For offshore wind farms, these subsea cables are buried into the seabed, which makes direct physical monitoring challenging once operational. However, these power cables suffer from physical damage from external forces like strong water currents, fishing nets, and anchors, which are characteristic of the offshore environment. Especially, exposed cables (not buried state) are more susceptible to critical damage from external forces. Since cable damage directly impacts downtime and incurs significant costs, monitoring offshore cables in wind farms as frequently as possible is essential to reliable production of electrical energy from such wind farms.

To assess the condition of these cables, remote operational vehicles (ROVs) are typically employed. However, operating ROVs in offshore environments involves substantial operational expenses, making this method infeasible for routine daily monitoring.

For daily monitoring of power cables in offshore wind farms, optical fiber sensing technologies, which utilize optical fibers as distributed sensing media, hold significant potential because the power cables are typically composite cables and include optical fibers for communications between wind turbines and onshore facilities.

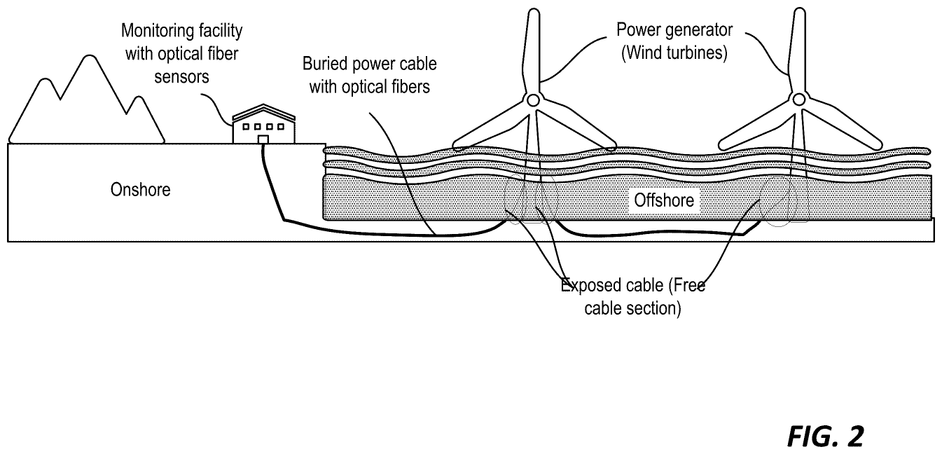

FIG. 2 is a schematic diagram showing an illustrative offshore windfarm with power cable and optical fiber sensor monitoring according to aspects of the present disclosure.

As depicted in the figure, shown is a typical setting of bottom-mounted offshore wind turbines with a subsea power cable monitoring system employing distributed fiber optic sensing (DFOS)/distributed acoustic sensing (DAS). As illustratively shown, optical sensor fiber(s) (that are the optical communications fibers included in the composite power cable) are connected to the DFOS/DAS system in an onshore monitoring facility to offshore turbines. As those skilled in the art will understand and appreciate, when the optical communications fiber is integrated with the DAS system, the optical communications fiber becomes a DAS optical sensor fiber which acts as a continuous sensor, having a virtually unlimited number of individual acoustic sensors along its entire length. The DAS data collected by these sensors are analyzed at the onshore facility, depicted with a building and an antenna.

As we previously noted, optical fiber sensing technologies enable the measurement of various physical quantities, such as the strain and temperature changes of the fiber, by detecting shifts in the corresponding backscattered light. For monitoring cable depth, the distributed temperature sensing (DTS) method is commonly used, utilizing Raman backscattered light (Raman OTDR, R-OTDR). This conventional approach assesses the burial depth of underwater power cables by analyzing the temperature of the fiber measured by DTS with its thermal response to electrical load variations, and historical load data based on thermal models. While static temperature data from the fiber, which typically takes over several hours, can provide estimates of the burial status of the cable, anomaly typically occurs dynamically. In addition, it is also difficult to identify what is happening once the exposed cable section appears only using the temperature information.

The problem of current solutions is lack of a cost-effective approach to continuously monitor the changes from buried to exposed cables in real time.

Advantageously, systems and methods according to aspects of the present disclosure provide a cost-effective way to continuously monitor the dynamic conditions described above by using distributed acoustic sensing (DAS), which detects the dynamic strain of the fiber through the phase changes in Rayleigh backscattered light (Phase-sensitive OTDR, Φ-OTDR). Specifically, it is possible to monitor the cable status using DAS in terms of (1) strength and propagation of the strain on buried power cable due to the wind wave and (2) early anomaly detection in the free cable sections, as described in detail below. Our invention focuses on monitoring the dynamic conditions of cables using DAS, changing from the buried cable sections into exposed free cable sections.

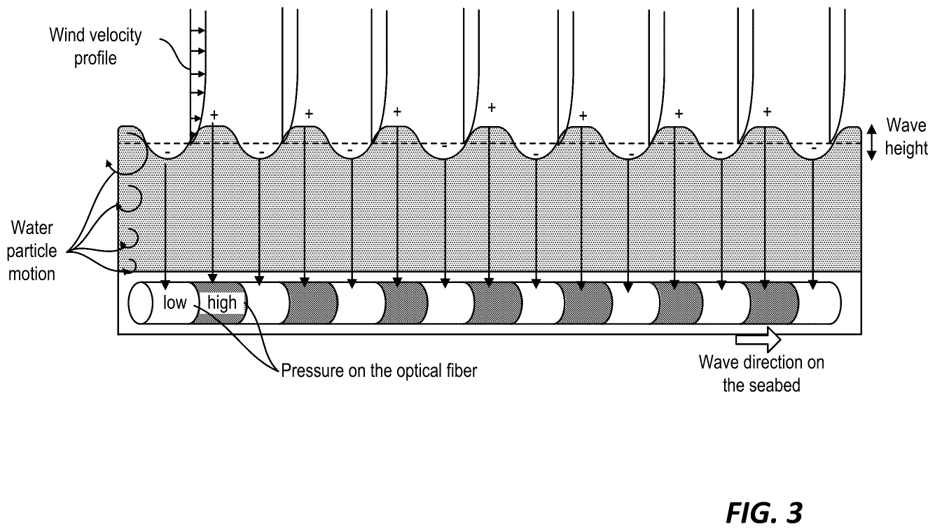

FIG. 3 is a schematic diagram showing illustrative relation between wind, sea wave height, and a buried optical fiber in the seabed according to aspects of the present disclosure.

This figure illustratively shows how DAS technology is applied to buried underwater power cables. In offshore wind farms, where strong winds are constant, friction between the wind and the sea surface, combined with gravity, induces wind waves. These waves create fluctuations in wave height, leading to variations in water pressure on the seabed that transfer to the buried optical fibers, producing strain patterns detectable by DAS. The typical strain patterns due to the wind waves has the wavelengths of order ˜10 m under the wind speeds around 20 km/h (i.e., frequencies of order 0.1 Hz to 1 Hz). Since the intensity of these fluctuations and the propagation speed are correlated with the wind strength, the dynamic status of the cables, influenced by wind, can be monitored in conjunction with the wind data

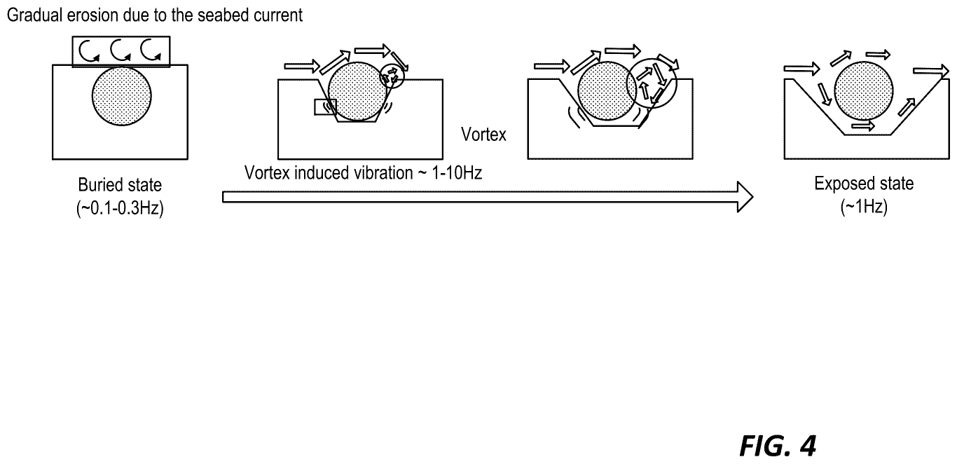

FIG. 4 is a schematic diagram showing illustrative changes in cable status, from buried to exposed according to aspects of the present disclosure.

As illustratively shown in FIG. 4, water particle motions generated by the surface propagate to the seabed and create currents on the seabed, particularly in shallow-depth environments. Therefore, sand, rocks, or other seabed material overlying the buried submarine cable gradually erode due to the currents. Once the submarine cable is exposed, it becomes susceptible to vortex-induced vibrations (VIV) caused by the interaction with the local seabed current. As the vortices grow, the intensity of VIV strengthens, leading to states where the submarine cable is completely exposed. Thus, once we observe a VIV pattern change indicative of the submarine cable being buried to exposed, we may intervene and dispatch a preventative maintenance operation because of our early detection using DFOS/DAS.

For our purposes as used herein, we have generally used the terms distributed acoustic sensing (DAS) and distributed vibration sensing (DVS) interchangeably. Those skilled in the art will understand and appreciate that In the realm of fiber optic sensing technology, the terms DAS and DVS are frequently used interchangeably or together to describe a single technology: Distributed Acoustic/Vibration Sensing.

While the acronyms stand for Distributed Acoustic Sensing (DAS) and Distributed Vibration Sensing (DVS), they both refer to systems that utilize optical fibers to detect and monitor vibrations and acoustic events along the entire length of the fiber cable.

As noted, the core principle behind both DAS and DVS is typically based on Phase-Sensitive Optical Time Domain Reflectometry (cp-OTDR). This technique involves sending laser pulses down an optical fiber and analyzing the backscattered light. External vibrations or acoustic waves interacting with the fiber cause minute changes in the properties of the scattered light. By analyzing these changes, the system can determine the location, intensity, and frequency of the disturbance.

Although some technical descriptions may differentiate between DAS and DVS based on the specific signal processing or demodulation techniques used (e.g., focusing on phase changes for “acoustic” sensing and amplitude changes for “vibration” sensing), the fundamental technology and its application in detecting physical disturbances along a distributed fiber are the same. Many industry professionals and resources use DAS and DVS as equivalent terms or combine them as DAS/DVS to encompass the technology's capability to sense both acoustic energy and vibrations.

Accordingly, based on the vibration mechanisms described above, we can monitor whether the cable is exposed, including real-time tendencies of wind and waves. To achieve this, our inventive systems and methods introduce a local index based on the intensity and frequency of dynamic strain, which can effectively monitor the cable's status as it transitions from a buried to an exposed state. By statistically analyzing the defined index, we can detect cable anomalies early, within an order of minutes

As will be understood and appreciated by those skilled in the art, our inventive systems and methods may advantageously provide the following: i) monitoring the cable sections changing from buried state to the exposed state based on the dynamic strain propagation; and ii) frequency/intensity analysis; and detecting the accurate locations of the exposed cable sections along the power cable and early anomaly detection

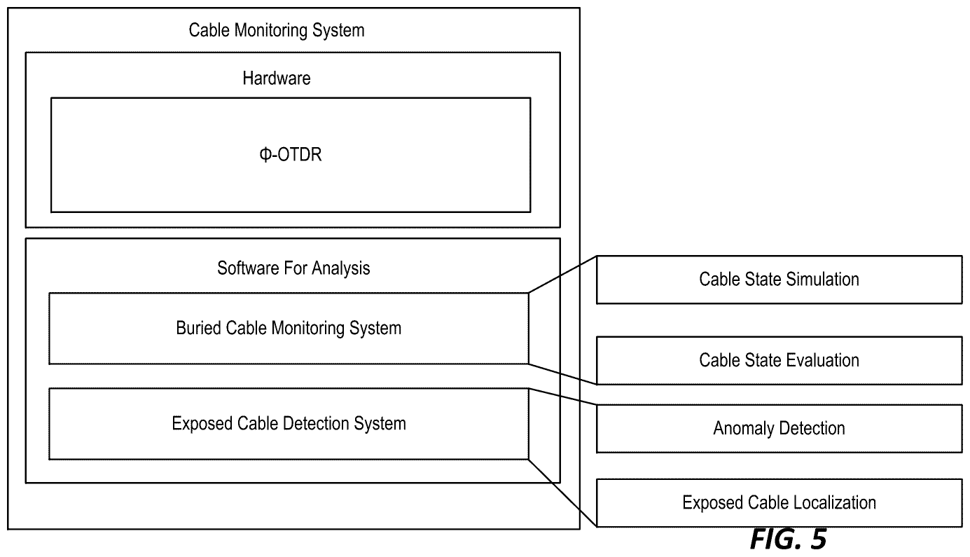

FIG. 5 is a schematic block diagram showing illustrative features of systems and methods according to aspects of the present disclosure.

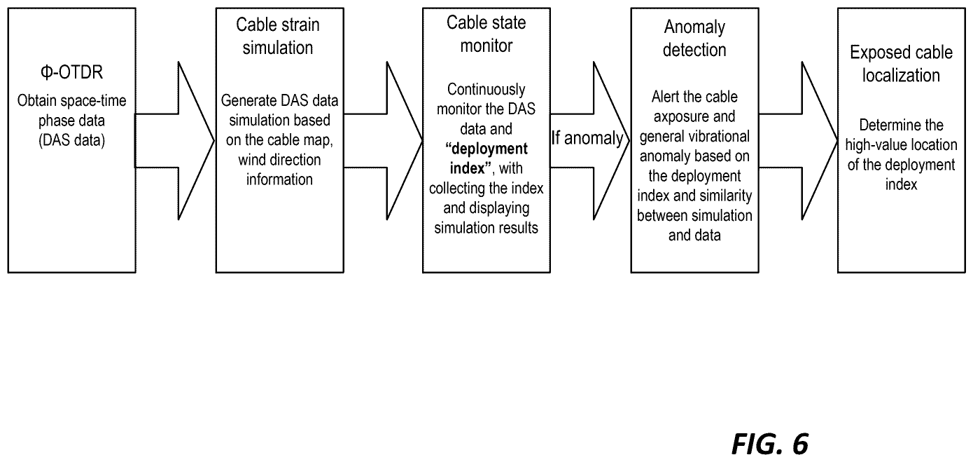

FIG. 6 is a schematic flow diagram showing illustrative operational aspects of systems and methods according to aspects of the present disclosure.

With simultaneous reference to these figures, it may be understood that these figures depicts the structure and operation flow of our inventive cable monitoring systems and methods, which include hardware—DAS based on Φ-OTDR—and two software systems executing on hardware and configured for analyzing and monitoring buried cable sections and exposed cable sections. The main components in our inventive systems and methods are a cable strain simulation and cable state evaluation operations, while another system includes a free cable localizer and cable status evaluator. Each component is described below.

### Hardware: DAS System Based on Φ-OTDR

Our inventive cable monitoring system and method utilizes DAS data recorded by DAS. Thus, the hardware based on Φ-OTDR is necessary to obtain the local dynamic strain of the optical fiber. The dynamic strain within a certain section of the subsea cable termed as gauge length is linear to the phase difference of Rayleigh backscattered light in the same section. Φ-OTDR is the reflectometer to obtain the phase data of backscattered light.

The space-time phase data is processed in two systems, a buried cable monitoring system and an exposed cable detection system independently. In the following, the components in the systems are explained in detail.

### Buried Cable State Estimator

As described with respect to FIG. 3, the water height distribution yields the pattern of the dynamic strain of the buried optical fiber. Thus, once the space-time phase data is obtained, we can estimate the wave state from the pattern in the buried fiber data. The wave state estimator estimates the state of the wind wave and wind itself from the fiber sensing data. The main components in the system are as follows.

### Cable Strain Simulation

Cable strain simulation simulates space-time data influenced by wind and waves, as sensed by buried optical fibers, with reference to current wave height and wind information. If there is a high similarity between the simulated and sensed phase data or dynamic strain data, we can estimate physical parameters of the wind wave from sensing data, such as its direction, wavelength, speed, and frequencies, which indicate the impact of wind waves on the cable.

Though any simulation works, a straightforward simulation for space-time phase data is carried out here, assuming the wind wave is a plane wave moving in a specific direction at the same speed as wind.

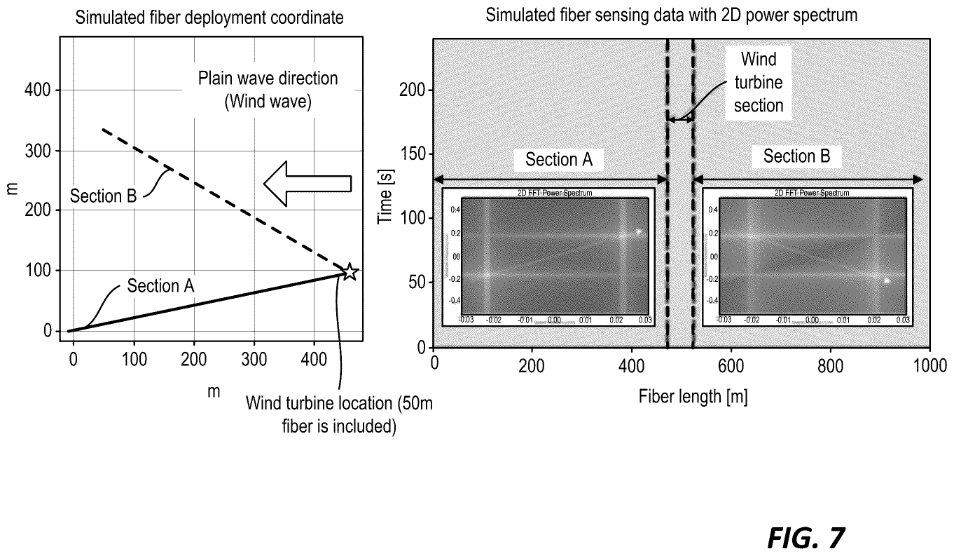

FIG. 7 is a plot showing illustrative fiber deployment in a simulation (left) and one of the simulated results plotted in space and time, and corresponding 2D power spectrums (right) according to aspects of the present disclosure.

The left side of FIG. 7 illustrates the simulated straight fiber deployments in sections A and B, depicted in a 2D space where each point represents a sensing location. The total fiber lengths are set to 1000 m, with a 50 m segment embedded within a wind turbine at the juncture of sections A and B. With the plane wave assumed to be traveling along the negative x-axis, the simulated space-time phase data also exhibits a 2D plane wave pattern, as displayed on the right side of FIG. 6. The propagation speed in each section differs according to the relative angles between the fiber sections and the wind wave's direction, meaning the propagation speed observed in the phase data does not match the actual wind wave velocity. This speed can be determined from the slope of the peak points in the 2D power spectrum, also depicted on the right of FIG. 7.

Once we acquire the actual fiber layout in real space, we can simulate the pattern and reconcile the patterns from simulated and experimental data by varying the frequency, propagation speed of the plane wave, and the wave direction

The wave height data can be collected using wave buoys or a high-frequency radar system. Since wind turbines typically possess their own wind speed meters, wind speed can also be referred.

In general, the speed of wind correlates with the height and period of wind wave, the buried cable will be affected by the wind indirectly but strongly. Specifically, the strength of the wind affects the amplitude and propagation speed of the phase data.

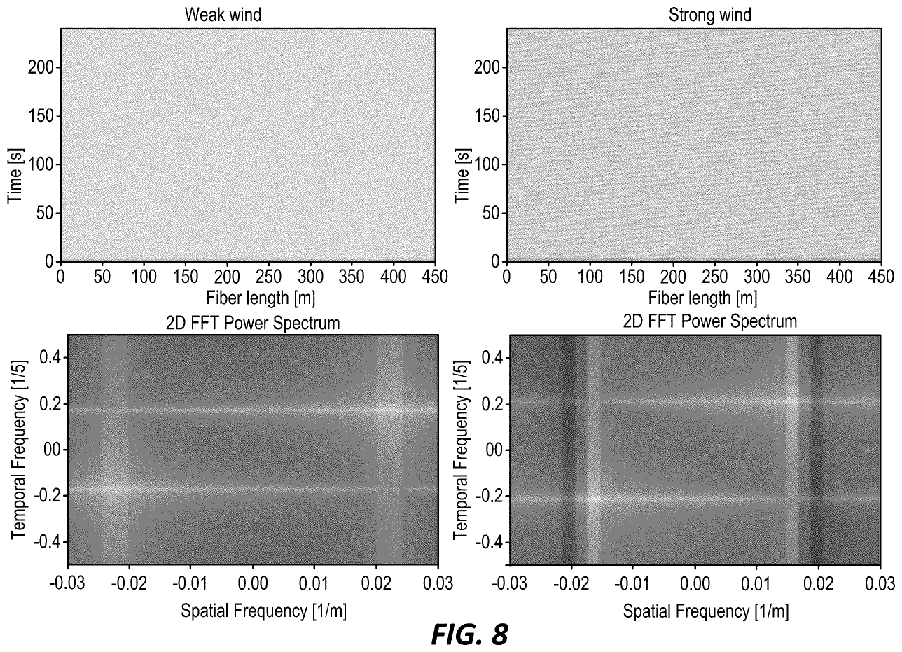

FIG. 8 shows a series of plots of illustrative simulated patterns of space-time phase data with 2D power spectrum according to aspects of the present disclosure. The simulated patterns show differences under the same fiber deployment and wind direction. Since strong water current will scour the seabed more frequently than the weaker one, it is necessary to pay attention to the sections with larger phase amplitude and propagation speed.

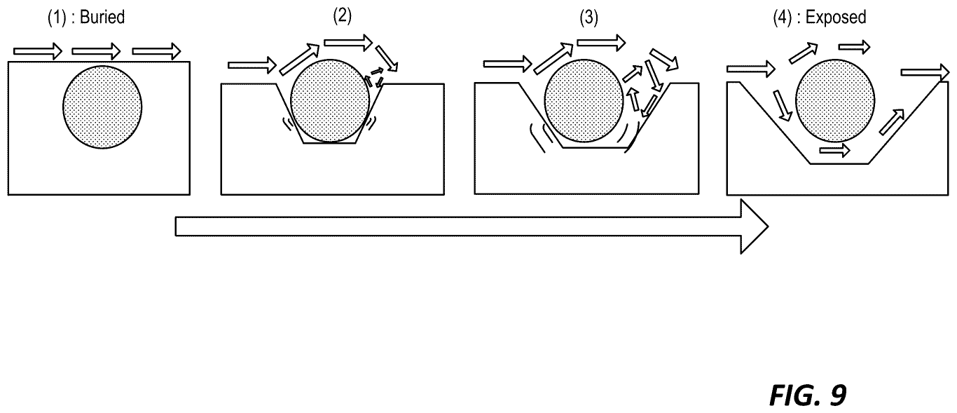

FIG. 9 shows an illustrative example of changes in a buried cable from buried to exposed according to aspects of the present disclosure.

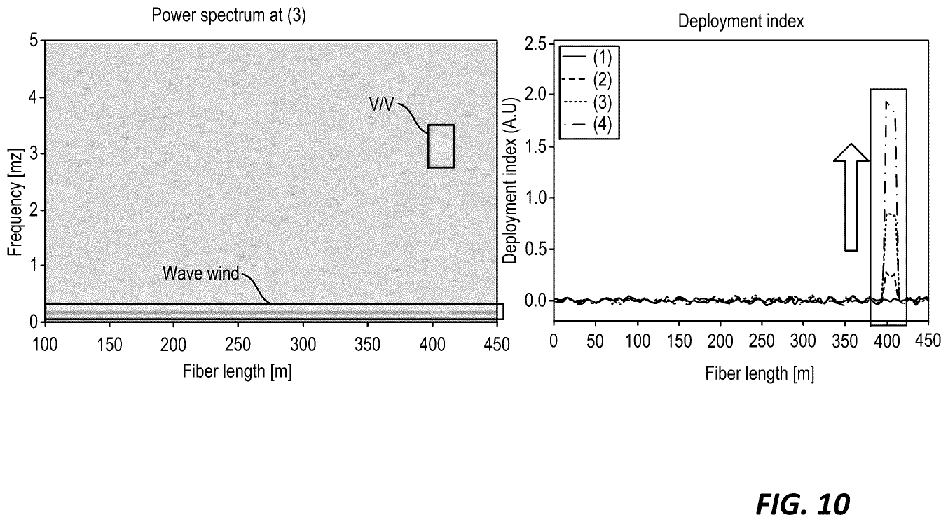

FIG. 10 shows a pair of plots of illustrative power spectrum when VIV affects the cable and deployment indices corresponding to changes in cable status as illustratively shown in FIG. 9, according to aspects of the present disclosure.

To effectively monitor cable deployment, the system introduces an evaluation index called the deployment index. As previously described, wind waves induce wave patterns on the cable below 1 Hz, while VIV occurs above 1 Hz, as illustrated in the power spectrum of FIG. 10.

To capture this feature, one of the deployment index forms calculated from the space-time phase data is given by DDᵢᵢ=average power above 1 Hz/average power below 1 Hz, where DDᵢᵢ is the deployment index at ii-th sensing point. Though it is difficult to predict to precise how VIV happens in every case in terms of intensity or frequencies of phase data, DDᵢᵢ gives the explicit evaluation index relative to the background vibration in buried state, as seen in FIG. 10. Note that operators can introduce various forms of the index, adjusting its frequency cutoffs and scales, to enhance visualization.

### Anomaly Detection and [2-2] Exposed Cable Localization

With the findings from cable strain simulation and cable status monitors, operators can continuously monitor the impact on cable state due to wind waves and exposure-related factors, mainly VIV, in real-time. To precisely determine whether the cable is exposing or not, it is effective to introduce a histogram for DDᵢᵢ.

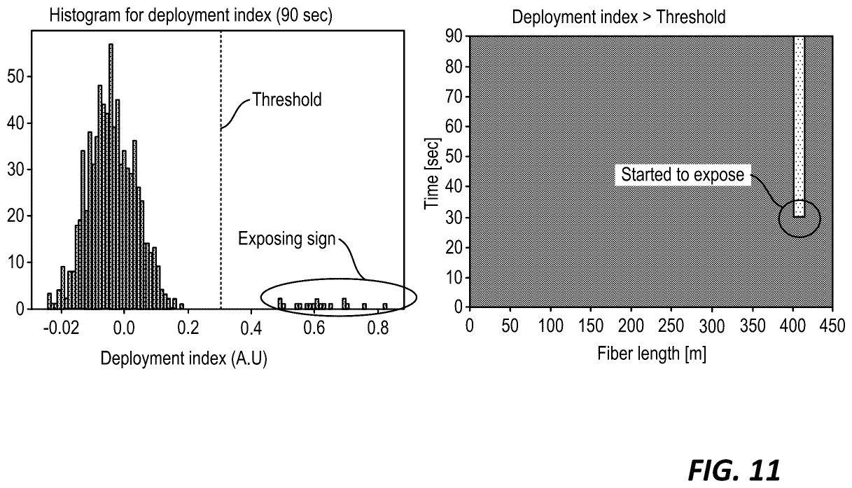

FIG. 11 shows a histogram of the deployment indices in 90 sec when the cable is exposing, and localization result based on the threshold according to aspects of the present disclosure.

The left of FIG. 11 shows an example for the histogram in 90 sec. This histogram allows us to visually understand the distribution of the index in the buried section with ease and set the threshold for decision making. A wider spread in the distribution indicates increasingly severe impacts on the cable. If we observe a distribution skewed towards higher-value indices, concentrated in a specific section, it indicates that the section is either exposed or experiencing other vibration anomalies, as detected and localized in the right of FIG. 11. With this analysis and the information of wind, wind wave, and their impact on the cable obtained in a cable strain simulation, we can accurately detect and localize the cable exposure while considering reasons for the cable exposure in various perspectives

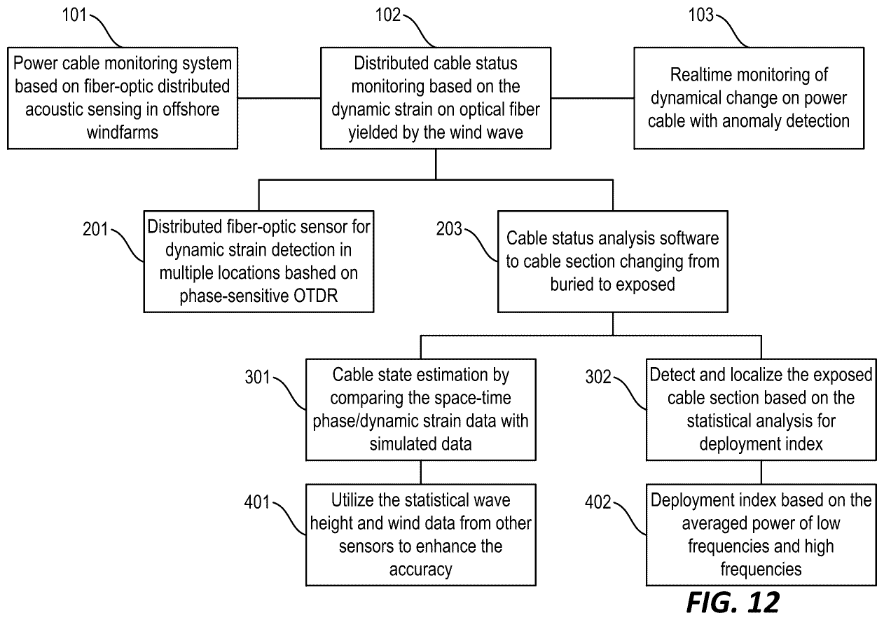

FIG. 12 shows a feature diagram in hierarchical format of features and operation steps of systems and methods according to aspects of the present disclosure.

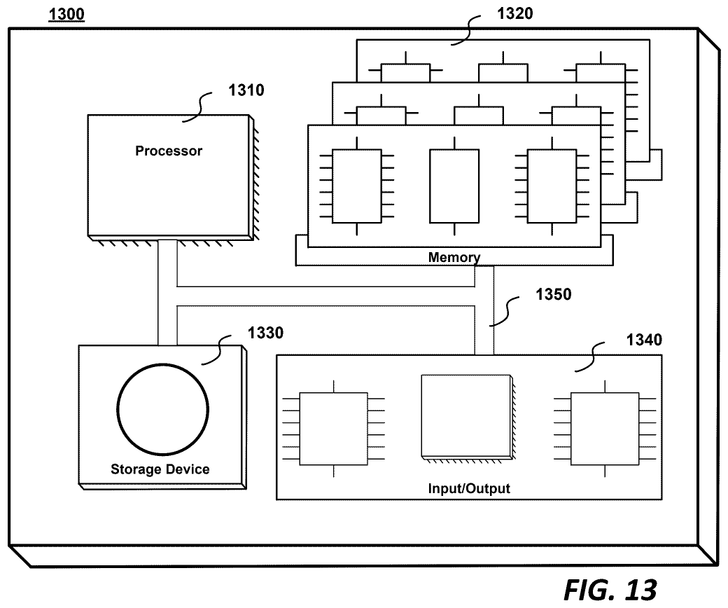

FIG. 13 is a schematic block diagram of an illustrative computer system in which aspects of the present disclosure may be executed to produce methods/algorithms according to aspects of the present disclosure.

As may be immediately appreciated, such a computer system may be integrated into another system such as a router and may be implemented via discrete elements or one or more integrated components. The computer system may comprise, for example, a computer running any of several operating systems. The above-described methods of the present disclosure may be implemented on the computer system 1300 as stored program control instructions.

Computer system 1300 includes processor 1310, memory 1320, storage device 1330, and input/output structure 1340. One or more input/output devices may include a display. One or more busses 1350 typically interconnect the components, 1310, 1320, 1330, and 1340. Processor 1310 may be a single or multicore. Additionally, the system may include accelerators etc., further comprising the system on a chip.

Processor 1310 executes instructions in which embodiments of the present disclosure may comprise steps described in one or more of the Drawing figures. Such instructions may be stored in memory 1320 or storage device 1330. Data and/or information may be received and output using one or more input/output devices.

Memory 1320 may store data and may be a computer-readable medium, such as volatile or non-volatile memory. Storage device 1330 may provide storage for system 1300 including for example, the previously described methods. In various aspects, storage device 1330 may be a flash memory device, a disk drive, an optical disk device, or a tape device employing magnetic, optical, or other recording technologies.

Input/output structures 1340 may provide input/output operations for system 1300.

While we have presented our inventive concepts and description using specific examples, our invention is not so limited. Accordingly, the scope of our invention should be considered in view of the following claims.

1. A computer-implemented method for monitoring subsea power cables in offshore wind farms, the method comprising:
collecting distributed fiber optic sensing (DFOS) data from a fiber optic sensor co-located with a subsea power cable; and
determining, from the DFOS data, whether one or more sections of the subsea power cable is buried or exposed.

2. The method of claim 1 further comprising determining a local index based on intensity and frequency of dynamic strain exhibited by the fiber optic sensor.

3. The method of claim 2 further comprising determining, from the local index, whether one or more section of the subsea power cable is transitioning from a buried status to an exposed status.

4. The method of claim 3 further comprising determining, a deployment index that is indicative of frequencies of wind wave patterns on the subsea power cable.

5. The method of claim 3 further comprising localizing exposed subsea power cable sections based on a statistical analysis of the deployment index.
